(19) United States
(12) Patent Application Publication
(10) Pub. No.: US 2006/0158018 A1
(43) Pub. Date: Jul. 20, 2006

(54) Balance weight, a wheel, a wheel rim and a wheel disc

(76) Inventors: Evandro Luis Francischetti, Limeira (BR); Nelson Gosser JR., Piracicaba (BR)

Correspondence Address: CARLSON, GASKEY & OLDS, P.C., 400 WEST MAPLE ROAD, SUITE 350, BIRMINGHAM, MI, 48009, US

(21) Appl. No.: 10/525,491

(22) PCT Filed: Jul. 10, 2003
(86) PCT No.: PCT/BR03/00092

§ 371 Date: Sep. 16, 2005

(30) Foreign Application Priority Data
Aug. 23, 2002 (BR) PI0203372-0

(51) Int. Cl. B60B 1/00

(52) U.S. Cl. 301/5.21

(57) ABSTRACT

A balance weight for use on automotive vehicles includes at least one body and at least one magnetic element. A wheel, a wheel rim and a wheel disc are used with the balance weight.

### REFERENCE TO RELATED APPLICATIONS

This application claims priority to PCT Application PCT/BR2003/000092 filed on Jul. 10, 2003, which claims priority to Brazilian Patent Application PI0203372-0 filed on Aug. 23, 2002.

### BACKGROUND OF THE INVENTION

The present invention relates to a wheel-balance weight for use on a vehicle wheel of an automobile vehicle. The wheel is made from stamped steel and includes a feature that fixes the weight to dynamically balance the wheel-tire assembly. The present invention also relates to a wheel rim and a wheel disc configured with the weight.

Conventional wheels made from stamped steel include a wheel rim for fixing a tire and a wheel disc. An end of the wheel rim includes a protuberant flange. In an alternative embodiment, the wheel from stamped steel includes a flange that is an integral part of the disc. The protuberant flanges are substantially perpendicular to the rest of the body and have a substantially “ [symbol] ” or “J” shaped curved profile.

The flange enables a wheel weight to be fixed to the wheel rim. The weight dynamically balances the wheel-tire assembly to prevent trepidation of a moving vehicle, particularly at a high speed, as a result of unbalancing. The balance weight is basically made of a metal, more usually of a high-density lead or another metal. A substantially U-shaped clamp projects that has a first end fixed to the metal body and a second end that is free to cooperate with the flange, as will be described later.

The wheel weight is positioned in a way to force its movement against the wheel, fixing the wheel weight. An opening of the U-shaped clamp permits cooperation with a free end of the flange. As the weight is pressed against the wheel, the clamp gradually opens until the metal body touches an inner surface of the flange. The clamp tends to return to its natural shape, thus applying a force onto the tip of the flange and generating a normal force to maximize friction between the clamp and the flange tip. This stabilizes the weight in its position, even when rotational movement of the wheel occurs.

In painted wheels, the friction provided by the U-shaped clamp is sufficient to maintain the weight in its position, even if the vehicle travels at high speeds or on rough roads. A drawback to painted wheels is that, with the friction caused by the U-shaped clamp, the paint at the location of friction is damaged from the moment of installation, thus causing financial losses to the user if he wants to sell the wheels in the near future. This also causes rusting of the wheel.

On the other hand, wheels made of stamped steel have the drawback of being aesthetically little attractive and are not often used on luxury vehicles. To solve this problem, a stamped steel wheel has been developed having a chromed finishing which is more attractive visually, making it commercially more acceptable. However, the chromed finishing reduces the coefficient of friction of the flange surface at the location where the clamp of the balance weight is fixed. As a result of the reduction in the coefficient of friction, the resultant friction force is not sufficient to keep the weight in the desired position, even if the installation is correct. This increases the chance that the balance weight may detach from the wheel when the vehicle is traveling on a rough road, which is a great drawback for those who use this type of wheel.

U.S. Pat. No. 6,238,006 discloses a wheel that includes a recess that retains a balance weight and that overcomes these drawbacks. The recess includes a shoulder that functions as stop for projecting the balancing clamp, so that both of them will function as a lock.

Although this embodiment eliminates the mentioned drawbacks, it needs a specific balance weight. The clamp includes a projection that locks the weight near to the wheel, rendering its use and/or installation less attractive.

Another solution is proposed in U.S. Pat. No. 5,733,016, which discloses a balance weight assembly on vehicle wheels. The wheel includes a flange having a concave recess and a balance weight having a U-shaped curvature at a free end of a clamp. This allows the clamp to fit into the recess so that it will be steadily fixed to the wheel. However, this embodiment still has the above-cited drawbacks.

Another drawback in the prior balance weights is the massive use of lead in manufacturing. Lead is a heavy metal, which can possibly cause diseases such as cancer. It is also an active environmental pollutant, as already been discussed. In this regard, the European Community Committee has established a time limit for the discontinued use of balance weights made of lead, mainly because the manufacturing process is polluting. For new vehicles, the time limit is Jul. 1^{st}, 2003. For vehicles already in circulation, the time limit is Jul. 1^{st}, 2005. In view of the time limits already approved by the European Parliament, companies that make balance weights should be mindful of projects that exclude lead from the manufacture of balance weights.

In addition, over time, the clamp that secures the balance weight near the wheel may corrode and detach. As a result, the user will have to use companies that specialize in balancing to balance the wheels, since the installation of the balance weight needs tools and skilled labor to carry out the service, causing a cost-and-time drawback.

In addition to the functional drawbacks, the balance weight has an unfavorable esthetic factor. The balance weight usually has the same color as the constituent material and is different from the color of the wheel, providing an unattractive contrast with the vehicle. Besides, as already stated, the wheel damages the paint of the wheel on which it is installed due to the friction between the wheel and the flange.

### SUMMARY OF THE INVENTION

A first objective of the present invention is to provide a magnetic balance weight for dynamically balancing vehicle wheels. A second objective of the present invention is to provide a wheel having a feature for fitting the balance weight. A third objective of the present invention is to provide a wheel disc for use on a wheel and having a feature for fitting the balance weight. A fourth objective of the present invention is to provide a wheel rim for use on a wheel and having a feature for fitting the balance weight.

The first objective of the present invention is achieved by a balance weight, especially for use on automotive vehicles, including at least one body and at least one magnetic element.

The second objective of the invention is achieved by a wheel, especially for use on automotive vehicles, provided with an associated rim and disc and including an end region having a free end. The end region has a cavity for association with a balance weight.

The third objective of the present invention is achieved by a wheel rim, especially for use on a wheel of automotive vehicles, including an end region having a free end. The end region has a cavity for association of a balance weight.

The fourth objective of the present invention is achieved by a wheel disc, especially for use on a wheel of automotive vehicles, including an end region having a free end. The end region has a cavity for association of a balance weight.

The invention has many advantages. For one, the balance weight of the magnetic wheel does not have clamps that can damage the paint of the wheel and may become loose and drop. Additionally, specific tools are not needed for the installation of the balance weight, making installation easier and less expensive. The present invention also favors the use of wheels having a surface finish with different degrees of rugosity, including a reduced rugosity, without losing the ability to fix the balance weight to the wheel. The balance weight may preferably be painted same the color as the wheel, which “camouflages” it. The balance weights of the present invention may be installed either in a groove or at any other point on the wheel, such as on the inside of the disc, since they are magnetic. The weights may also be used on prior art wheels.

### BRIEF DESCRIPTION OF THE DRAWINGS

The present invention will now be described in greater detail with reference to an embodiment represented in the drawings. The figures show:

FIG. 1 is a cross-sectional view of a wheel flange with a balance weight of the prior art being fixed;

FIG. 2 is a cross-sectional view of a flange of a wheel that has a cavity for inserting a magnetic balance weight of the present invention;

FIG. 3 is a cross-sectional view of the wheel illustrated in FIG. 2 with the magnetic balance weight fixed to it;

FIG. 4 is a cross-sectional view of the flange of a wheel of the prior art including a first alternative embodiment of the magnetic balance weight; and

FIG. 5 is a cross-sectional view of the flange of the wheel of the prior art including a second alternative embodiment of the magnetic balance weight.

### DETAILED DESCRIPTION OF THE PREFERRED EMBODIMENT

According to a preferred embodiment and as can be seen in FIG. 2, the wheel of the present invention includes a cylindrical wheel rim and a substantially circular wheel disc associated to each other.

The wheel rim includes at least one end region, called a flange 1, which is protuberant and constitutes a region of maximum diameter of the wheel. The flange 1 has a free end 7 and a body 2, the free end 7 projecting substantially parallel from the body 2 and defining a substantially “ [symbol] ” or “J” shaped profile. Usually, the wheel rim has two flanges 1 located at their two ends, and both of the flanges 1 enable one to fix and position a tire (not shown) onto the wheel.

Optionally, the wheel includes a rim that defines one of the flanges 1, and the disc defines the other flange 1. When these components are associated to each other, the functional result is similar to that achieved by the wheel that includes the two flanges 1.

The two wheel flanges 1 and the rest of the rim wall or disc wall define a groove in which a tire is placed, and the side wall 7 near an opening, usually known as a bead, is propped by the flanges 1. When the tire is inflated, the force exerted by it and resulting from the compressed air keeps the tire positioned, preventing any movement of the bead with respect to the flange 1.

The flange 1 has a cavity 3 that defines a notch for a balance weight 4, which is used to dynamically balance the wheel-tire assembly and to prevent trepidation in the vehicle if it is traveling at a high speed as a result of unbalancing.

The cavity 3 is preferably annular, but it may have other shapes or even be segmented. The cavity 3 includes side walls 3a which act as latches for the balance weight 4, preventing the balanced weight 4 from being displaced during the radial movement of the wheel and forcing the balance weight 4 to follow its movement. The side walls 3a generate a centripetal force that helps the magnetic force to keep the balance weight 4 correctly installed.

In the preferred embodiment, the cavity 3 has a substantially semicylindrical bottom surface from which the side walls 3a project to provide a groove shape.

The balance weight 4 includes two layers. A layer 4a is preferably made of a metallic material instead of lead, since the use of balancing weights including lead will be prohibited because lead is a heavy metal that causes damage. A layer 4b is made of any magnetic material that fixes the balance weight 4 into the cavity 3.

The balance weight 4 is preferably shaped as an annular segment that cooperates with the cavity 3. In the preferred embodiment, as can be seen in FIGS. 2 and 3, the balance weight 4 is fixed into the cavity 3 by the magnetic layer 4b and secured in a clean and easily usable way.

The cavity 3 fixes the balance weight 4 and prevents it from falling out of the cavity 3 while the tire is turning, as already mentioned. Alternatively, the cavity 3 may be provided at any location in the wheel, for example on the inside of the disc. Alternately, the tire may not include a cavity 3.

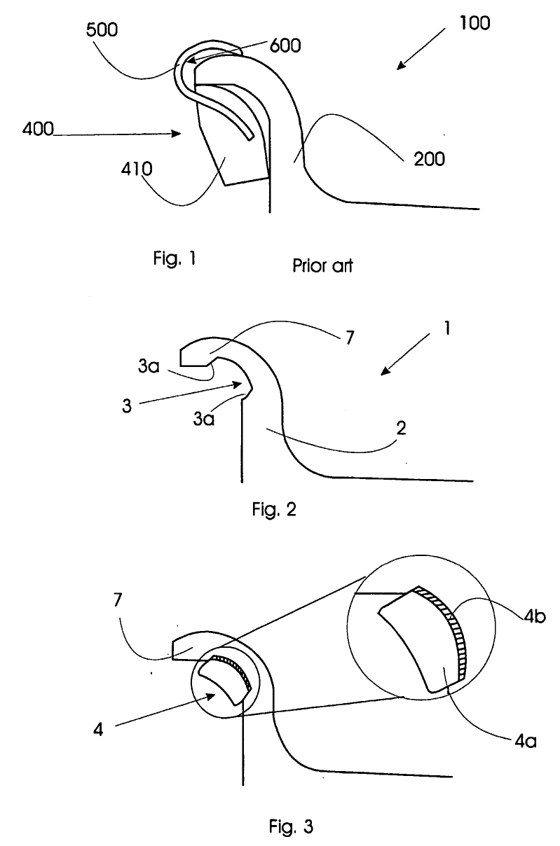

As shown in FIG. 1, the balance weight 400 of the prior art includes a clamp 500 and a body 410, preferably but not compulsorily metallic, and the installation is explained below.

The clamp 500 is substantially U-shaped and includes a main edge associated to the metal body 410, a second free end, and an internal wall surface 600 facing the flange 100 when the balance weight 400 is associated to it.

In the prior art, the wheel and the balanced weight 400 are fixed by the friction of the internal surface 600 of the clamp 500 with the flange 100. Movement of the balance weight 400 causes it to be forced against the flange 100, gradually opening the clamp 500 when the assembly moves until the metallic body 410 touches the flange body. This movement causes the clamp 500 to be forced in an open position, and it tends to return to its natural shape when a perpendicular force is applied around the wheel flange 100 to fix and maintain the balance weight 400 in the correct position.

The balance weight 4 of the present invention eliminates the drawbacks in the prior art cited above. The friction between the balance weight 400 of the prior art and the flange 1, especially in the installation of painted wheels, causes the paint to wear, scratching and damaging it. In the preferred embodiment, the edges of the balance weight 4 are preferably rounded to prevent, as much as possible, damage to the paint contacting the cavity 3. The magnetic fixing, besides being environmentally clean, eliminates the need for the clamp 5. The installation of the balance weight 4 becomes more practical, reducing the cost of labor since there is no need to use specific tools, enabling one to install the balance weight 4 more easily and at a reduced cost.

By eliminating the clamp 5, the visual aesthetics of the wheel are improved, providing a benefit. Further in the area of aesthetics, the balance weight 4 may preferably be painted the same color as the wheel, thus “camouflaging” it.

The balance weights 4 of the present invention may be installed in the groove or at any other point on the wheel, for example inside of the disc.

Evidently, any type of wheel can be provided with the cavity 3 that configures a notch for the balance weight 4 with a magnetizable layer 4b. For example, wheels composed of a rim and a disc and stamped from steel can not only be used, but also cast wheels, spoked wheels, and wheels made from other materials.

In the present invention, wheels with a surface finish having different rugosity can be used, including wheels with reduced rugosity. The geometry and thickness of the flange 1 and of the cavity 3 may vary, as well as the size of the balance weight 4, depending upon the size of the wheel to be installed. Even a wheel configured in this way will continue to be within the scope of the invention.

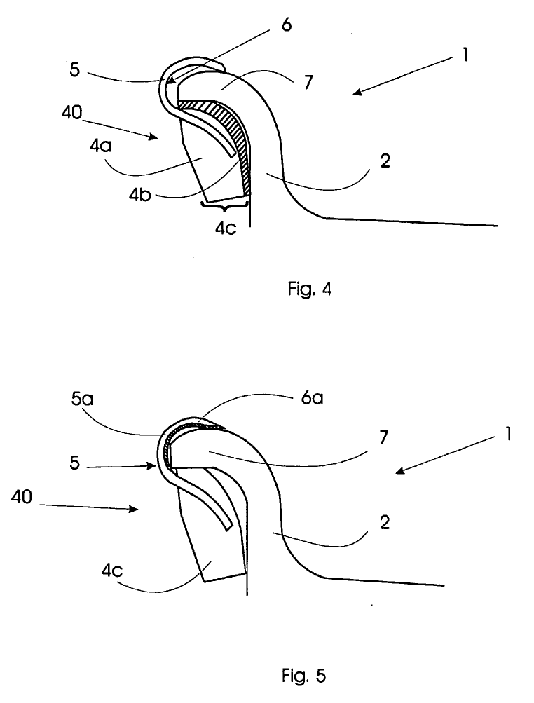

This configuration may only be implemented on new wheels that have just come from the factory. Following the same concept, new alternative configurations of the magnetic wheel weight have been developed which may be used on any type of wheel, as can be seen in FIGS. 4 and 5.

On existing wheels that are presently in use, the change and/or placement of the balance weight 400 should be constantly checked due to the poor conditions of the public roads. Since it is difficult to change a present wheel into a wheel with a cavity 3 because of the high cost, a first alternative configuration of a balance weight 40 has been developed which uses the same concept of the balance weight 4 disclosed above which can be used on present-day wheels. As already said, the present-day balance weight 400 is fixed to the wheel flange 100 by friction, and its fixation reliability is limited. On the other hand, the balance weight 40, as can be seen in FIG. 4, is fixed by a substantially U-shaped clamp 5, and one of the ends is fixed to a preferably but not compulsorily metallic body 4c. The metallic body 4c includes two layers 4a and 4b. The first layer 4a can be made of any material, and the second layer 4b is made of a magnetic material. The balance weight 40 also includes a second end including an internal wall 6 analogously fixed to the conventional weights at the free end 7 of the flange 1. The magnetic layer 4b offers greater reliability in fixing the balance weight 40, since the metallic body 4c will be magnetically fixed to the flange 1 by the layer 4b in addition to the usual fixation by the clamp 5.

Preferably, the balance weight 4 and the magnetic body 4c are made of lead, and the layer 4b is made of a ferromagnetic material. However, when the prohibition of use of lead for making balance weights goes into affect, the preferred material will be steel because of its abundance, low cost and relatively high specific weight. Alternately, another material having characteristics similar to those of steel and compatible with the magnetizable layer can be used.

FIG. 5 discloses a second alternative embodiment of the balance weight 40′ using a clamp 5 having two layers. The first layer 5a is made of any material (preferably metallic), and the second layer 6a is made of a magnetic material. The balance weight 40′ is fixed by the clamp 5 using the procedure already described, in addition to the magnetic force applied by the second layer 6a near the free end 7 of FIG. 1, strengthening the fixation of the balance weight 40′ to the wheel.

Moreover, both the clamp 5 and the balance weight [[4]]40 and 40′ may be jointly provided with a magnetizable layer 6a and 4b, respectively, achieving an even more satisfactory result in fixing the balance weight 40 and 40′, or else any other desired configuration may be foreseen. The balance weight 40 and 40′ may be used on any wheel of the prior art, as well as on the preferred embodiment. The magnetized weight 4 of the preferred embodiment may be installed and used on the wheel of the prior art, on any other type of wheel of an automotive vehicle, or on any other necessary or desirable combination.

The invention may be additionally used for balancing other wheels or substantially circular or non-circular bodies that are not compulsorily used for automotive vehicles.

Examples of preferred embodiments having been described, it should be understood that the scope of protection of the present invention embraces other possible variations, being limited only by the contents of the accompanying claims, which include the possible equivalents.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A balance weight for use on a vehicle, the balance weight comprising:
at least one body having at least one magnetic element.

2. The balance weight according to claim 1, wherein the at least one body has a shape of an annular segment.

3. The balance weight according to claim 1, wherein the at least one body is substantially metallic.

4. The balance weight according to claim 1, wherein the at least one magnetic element comprises a magnetic layer.

5. The balance weight according to claim 1, further comprising a clamp associated with the at least one body.

6. The balance weight according to claim 5, wherein the clamp includes a magnetic layer.

7. The balance weight according to claim 5, wherein the clamp is substantially U-shaped.

8. A wheel for use on vehicle including a rim and a disc, the wheel comprising:
a balance weight including at least one body having at least one magnetic element; and
an end region having a free end and a cavity receiving the balance weight.

9. The wheel according to claim 8, wherein the cavity is substantially annular in shape and includes a substantially semicylindrical bottom surface and two side walls that project from the substantially semicylindrical bottom surface to provide a groove-like shape.

10. A wheel rim for use on a wheel of vehicle, the wheel rim comprising:
a balance weight including at least one body having at least one magnetic element; and
an end region having a free end and a cavity receiving the balance weight.

11. The wheel rim according to claim 10, wherein the cavity has a substantially annular shape and includes a substantially semicylindrical bottom surface and two side walls that project from the substantially semicylindrical bottom surface to provide a groove-like shape.

12. A wheel disc for use on a vehicle, the wheel disc comprising:
a balance weight including at least one body having at least one magnetic element; and
an end region having a free end and a cavity receiving the balance weight.

13. The wheel disc according to claim 12, wherein the cavity has a substantially annular shape and includes a substantially semicylindrical bottom surface and two side walls that project, from the substantially semicylindrical bottom surface to provide a groove-like shape.

14. The balance weight according to claim 2, wherein the at least one body is substantially metallic.

15. The balance weight according to claim 2, wherein the at least one magnetic element comprises a magnetic layer.

16. The balance weight according to claim 3, wherein the at least one magnetic element comprises a magnetic layer.

17. The balance weight according to claim 6, wherein the clamp is substantially U-shaped.
